(19) United States
(12) Patent Application Publication
(10) Pub. No.: US 2025/0365300 A1
(43) Pub. Date: Nov. 27, 2025

(54) SYSTEM AND METHOD FOR GENERATING FRAUD REPORT USING LARGE LANGUAGE MODEL

(71) Applicant: Barracuda Networks, Inc., Campbell, CA (US)

(72) Inventors: Seyed Armin Seyeditabari, San Francisco, CA (US); Mohamed Hossam Afifi Ibrahim, San Jose, CA (US)

(21) Appl. No.: 19/196,556

(22) Filed: May 1, 2025

Related U.S. Application Data
(60) Provisional application No. 63/651,363, filed on May 23, 2024.

(51) Int. Cl. H04L 9/40

(52) U.S. Cl. CPC H04L 63/1425; H04L 63/1483

(57) ABSTRACT

A new approach is proposed that supports large language model (LLM)-driven fraud report generation. First, a plurality of features is extracted/derived either directly from an original piece of content/information susceptible of fraud or indirectly from one or more external sources (e.g., statistical data) associated with the piece of content. The plurality of extracted features are then classified into one or more fraud categories using one or more classification models. If a fraud attack is detected, an input prompt is generated based on the plurality of extracted features and the one or more fraud categories related to the specific detection in order to generate a report for a user as to the reason for this detection. Finally, a LLM is utilized to generate a fraud report of the original piece of content for the user based on the input prompt specific to the one or more fraud categories.

### CROSS-REFERENCE TO RELATED APPLICATIONS

This application claims the benefit of U.S. Provisional Patent Application No. 63/651,363, filed May 23, 2024, which is incorporated herein in its entirety by reference.

### BACKGROUND

In today's digital age, organizations are facing a multitude of cyber-attacks launched with fraudulent content in various forms and formats, e.g., via electronic messages or emails. A diverse array of machine learning (ML) models and algorithms, such as large language models (LLMs) and multimodal models, are employed by the organizations for the identification of the fraudulent content, aiming to safeguard customers from potential financial and reputational risks posed by such cyber-attacks. These ML models are usually trained on vast amounts of text in order to understand and classify existing fraudulent content of the electronic messages.

In many cases, users of these ML model-based systems may seek clarification on the reasons behind the blocking of the fraudulent contents, such as phishing emails, based on reports from these LLM-based systems. Given the utilization of multiple ML models with diverse features to detect various categories of the fraudulent contents, the generation of consistent reports customized for the users proves to be a significant challenge, often deemed impractical.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support large language model (LLM)-driven fraud report generation in accordance with some embodiments.

FIG. 2 depicts an example of a phishing email utilized by a hacker to launch a phishing attack

FIG. 3 depicts a flowchart of an example of a process to support large language model (LLM)-driven fraud report generation in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support large language model (LLM)-driven fraud report generation. First, a plurality of features is extracted/derived either directly from an original piece of content/information susceptible of fraud or indirectly from one or more external sources (e.g., statistical data) associated with the piece of content. The plurality of derived features is then classified into one or more fraud categories using one or more classification models. If a fraud attack is detected, an input prompt is generated based on the plurality of extracted features and the one or more fraud categories related to the specific detection in order to generate a report for a user as to the reason for this detection. Finally, a LLM is utilized to generate a fraud report of the original piece of content for the user based on the input prompt specific to the one or more fraud categories.

By leveraging a LLM to systematically generate the fraud reports, the proposed approach can personalize the fraud reports to be specific to one or more fraud categories and do not need human analysis of the piece of content. Furthermore, the classification models used for fraud detection considers features extracted from the piece of content directly for fraud detection and classification. As such, the proposed approach removes the need for secondary models specifically designed for each fraud category to explain the fraud detection results from the classification models.

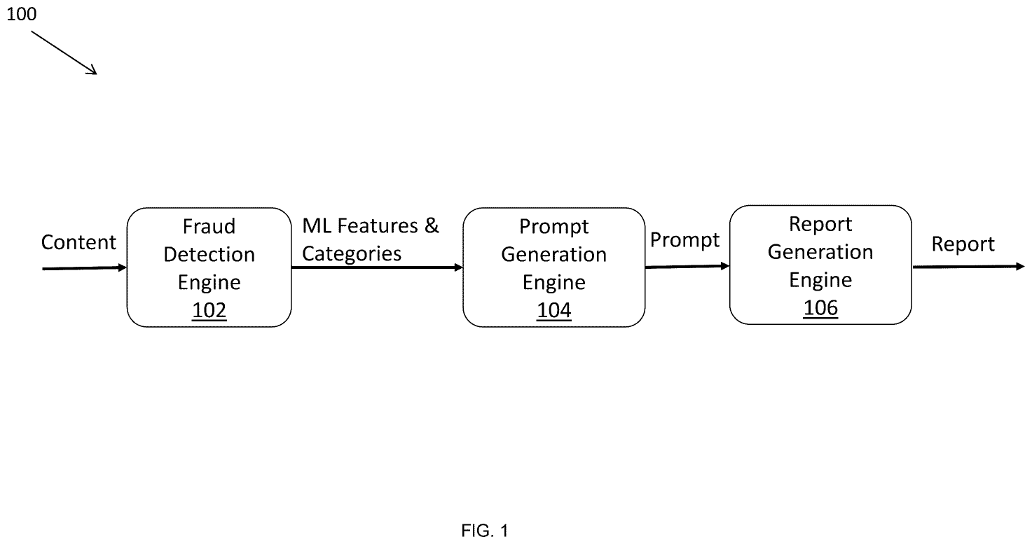

FIG. 1 depicts an example of a system diagram 100 to support LLM-driven fraud report generation. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a fraud detection engine 102, a prompt generation engine 104, and a report generation engine 106. Each engine in the system 100 runs on one or more computing units/appliances/devices/hosts (not shown) each having one or more processors and software instructions stored in a storage unit, such as a non-volatile memory of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google Android device, an iPhone, an iPad, and a voice-controlled speaker or controller. Each engine in the system 100 is associated with one or more communication networks (not shown), which can be but are not limited to, Internet, intranet, wide area network (WAN), local area network (LAN), wireless network, Bluetooth, Wi-Fi, and mobile communication network for communications among the engines. The physical connections of the communication networks and the communication protocols are well known to those skilled in the art.

In the example of FIG. 1, the fraud detection engine 102 is configured to receive a piece of original content. For non-limiting examples, the piece of original content can be but is not limited to an electronic document or electronic message, such as an email or an instant message, containing one or more types of content elements such as text, web link, image, video, and other types of media content. Here, the piece of original content may come from a diverse range of information sources, making it susceptible of having fraudulent content elements used to launch a cyber-attack. The fraud detection engine 102 is then configured to derive, e.g., extract, a plurality of features from the piece of content for fraud detection. Here, the plurality of machine learning features can be machine learning related. In some embodiments, the fraud detection engine 102 is configured to extract the plurality of features either directly from the piece of content or indirectly from external sources, e.g., statistical data, associated with the piece of content. For non-limiting examples, each of the plurality of features can be but is not limited to text, email address reputation, number of redirects for one or more links embedded in the piece of content, etc. Once the plurality of features has been extracted, the fraud detection engine 102 is configured to classify the plurality of features of the piece of content into one or more fraud categories using one or more classification models. Here, the one or more fraud categories classify if the piece of content is fraudulent and if so, what fraud category(s), e.g., phishing, the piece of content belongs to. In some embodiments, each of the classification models is a type of AI algorithm that uses deep learning and/or other machine learning techniques to recognize and classify the plurality of features. In some embodiments, the fraud detection engine 102 is configured to transform the plurality of derived features into a set of numerical values representing the one or more fraud categories to facilitate classification by the one or more classification models. In some embodiments, classification models having different parameters can be utilized for fraud detection as described in U.S. Pat. Pub. No. US2024/0356948A1, which is incorporated herein in its entirety by reference. In some embodiments, the fraud detection engine 102 is further configured to block the piece of content, if the piece of content is classified as fraudulent. The fraud detection engine 102 then provides the plurality of derived features and their corresponding one or more fraud categories to the prompt generation engine 104 for input prompt generation.

In the example of FIG. 1, the prompt generation engine 104 is configured to accept as its input the plurality of features detected/extracted from the piece of original content and/or the one or more fraud categories classified from the plurality of features by the one or more classification models. The prompt generation engine 104 is then configured to generate an input prompt specific to the one or more fraud categories, wherein the category-specific input prompt is then utilized by a LLM of the report generation engine 106 to generate a fraud report to a user. In some embodiments, the input prompt is pre-defined/specified by a user for each of the one or more fraud categories. In some embodiments, the prompt generation engine 104 is configured to accept a plurality of pre-defined category-specific prompts from the user and maintain one or more pairs of the plurality of pre-defined category-specific prompts together with their corresponding fraud categories in a lookup table. When the one or more fraud categories are received, the prompt generation engine 104 is configured to look up the received one or more fraud categories and retrieve the corresponding input prompt from the lookup table. The prompt generation engine 104 then incorporates the received features into the corresponding prompt to create the final input prompt and passes the input prompt specific to the one or more fraud categories to the report generation engine 106.

In the example of FIG. 1, the report generation engine 106 is configured to accept the input prompt specific to the one or more fraud categories and utilize a LLM to generate a fraud report for the user about the original piece of content based on the input prompt. Specifically, the LLM harnesses capabilities of generative AI and pertinent information regarding the piece of content, e.g., the plurality of derived features (both direct and indirect) crafted for the classification model, the one or more classified fraud categories, and the category-specific prompt. Subsequently, the LLM formulates a concise fraud report pinpointing the section of the piece of content and/or features that exhibit suspicious characteristics. In some embodiments, the LLM is able to generate the fraud report that includes one or more of text, images, videos, or other forms of data at the input prompt using generative AI capability. In some embodiments, the report generation engine 106 is configured to generate the fraud report at the input prompt either automatically without manual intervention by a human operator or upon a request from the user. In some embodiments, the report generation engine 106 is configured to personalize the generated fraud report to provide one or more insights for the user, e.g., indicating the reasons for specific piece of content to be blocked, wherein the report does not fit in a predesigned report form structure. In some embodiments, the report generation engine 106 contains a fine-tune LLM by utilizing previously available data. Here, such previously available data includes but is not limited to previously generated fraud reports, by such report generation engine 106 or humans for the same or similar input prompt and/or specific to the one or more fraud categories, the plurality of features extracted from the piece of original content for which the current fraud report is generated, etc.

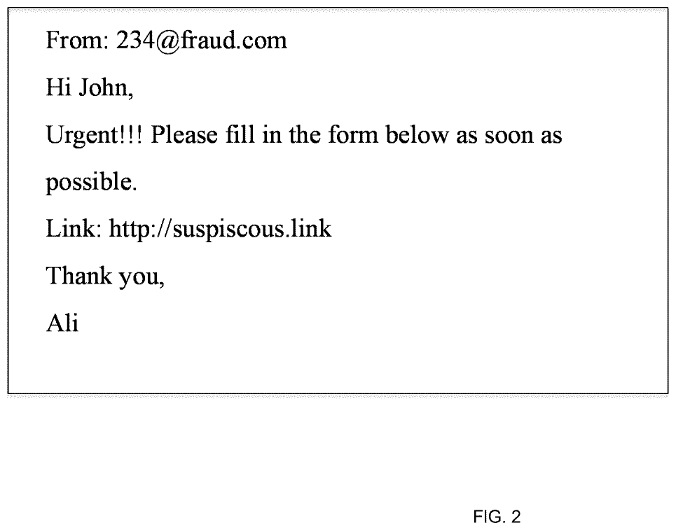

FIG. 2 depicts an example of an original piece of content, which is a phishing email utilized by a hacker to launch a phishing attack. The fraud detection engine 102 extracts a plurality of features the email, such as email address information and reputation, text content, link information and reputation, etc., and classifies and blocks this email as high likelihood of being a phishing attack using a phishing classifier as the classification model. The prompt generation engine 104 identifies and retrieves an input prompt specific to the fraud category of phishing emails and provides the input prompt to the report generation engine 106. Based on the input prompt, the LLM of the report generation engine 106 generates a fraud report to the user. For non-limiting examples, the fraud report may include one or more of the following:
This email (as shown in FIG. 2) has been blocked due to a potential phishing threat.
The sender is outside your company and using an email provider address with a sender name that impersonates a known service.
The link provided in the email has multiple redirections with high fraud reputation, and the text implies a sense of urgency with phrases like “Urgent!!!” and “as soon as possible”, which are features commonly seen in a phishing email.

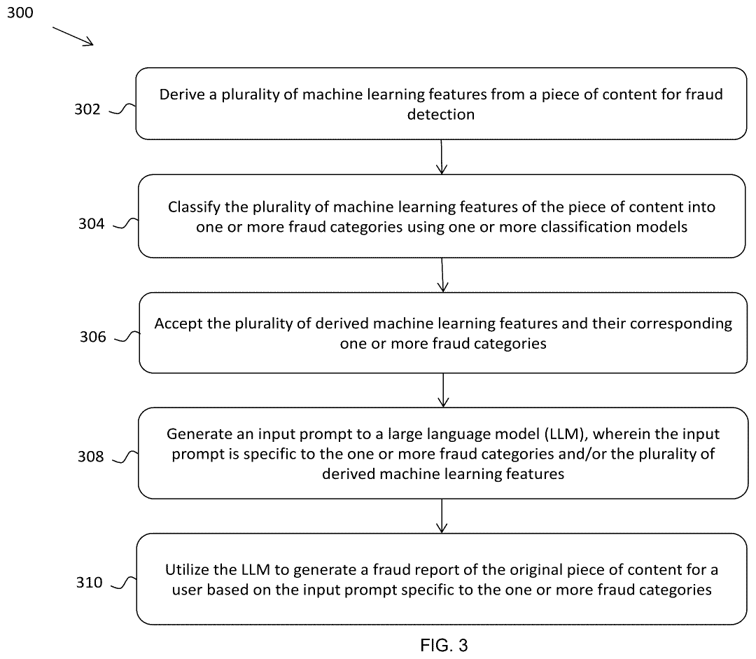

FIG. 3 depicts a flowchart 300 of an example of a process to support LLM-driven fraud report generation. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where a plurality of machine learning features are derived from a piece of content for fraud detection. The flowchart 300 continues to block 304, where the plurality of machine learning features of the piece of content are classified into one or more fraud categories using one or more classification models. The flowchart 300 continues to block 306, where the plurality of derived machine learning features and their corresponding one or more fraud categories are accepted. The flowchart 300 continues to block 308, where an input prompt to a large language model (LLM) is generated, wherein the input prompt is specific to the one or more fraud categories and/or the plurality of derived machine learning features. The flowchart 300 ends at block 310, where the LLM is utilized to generate a fraud report of the original piece of content for a user based on the input prompt specific to the one or more fraud categories.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine-readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
a fraud detection engine configured to
derive a plurality of features from a piece of content for fraud detection;
classify the plurality of features of the piece of content into one or more fraud categories using one or more classification models;
a prompt generation engine configured to
accept the plurality of derived features and their corresponding one or more fraud categories;
generate an input prompt to a large language model (LLM), wherein the input prompt is specific to the one or more fraud categories and/or the plurality of derived features; and
a report generation engine configured to utilize the LLM to generate a fraud report of the original piece of content for a user based on the input prompt specific to the one or more fraud categories.

2. The system of claim 1, wherein:
the piece of content is an electronic message containing one or more types of content elements.

3. The system of claim 1, wherein:
the fraud detection engine is configured to derive the plurality of features either directly from the piece of content or indirectly from an external source associated with the piece of content.

4. The system of claim 1, wherein:
the fraud detection engine is configured to transform the plurality of derived features into a set of numerical values representing the one or more fraud categories to facilitate classification by the one or more classification models.

5. The system of claim 1, wherein:
the fraud detection engine is configured to block the piece of content if the piece of content is classified as fraudulent.

6. The system of claim 1, wherein:
the input prompt is pre-defined by a user for each of the one or more fraud categories.

7. The system of claim 6, wherein:
the prompt generation engine is configured to
accept a plurality of pre-defined category-specific prompts from the user; and
maintain one or more pairs of the plurality of pre-defined category-specific prompts together with their corresponding fraud categories in a lookup table.

8. The system of claim 7, wherein:
the prompt generation engine is configured to look up the one or more fraud categories and retrieve the corresponding input prompt from the lookup table.

9. The system of claim 1, wherein:
the report generation engine is configured to generate the fraud report at the input prompt either automatically without manual intervention by a human operator or upon a request from the user.

10. The system of claim 1, wherein:
the report generation engine is configured to personalize the generated fraud report to provide one or more insights for the user.

11. The system of claim 1, wherein:
the report generation engine is configured to fine-tune the LLM by utilizing previously available data.

12. The system of claim 11, wherein:
the previously available data includes previously generated fraud reports for the same or similar input prompt.

13. A computer-implemented method, comprising:
deriving a plurality of features from a piece of content for fraud detection;
classifying the plurality of features of the piece of content into one or more fraud categories using one or more classification models;
accepting the plurality of derived features and their corresponding one or more fraud categories;
generating an input prompt to a large language model (LLM), wherein the input prompt is specific to the one or more fraud categories and/or the plurality of derived features; and
utilizing the LLM to generate a fraud report of the original piece of content for a user based on the input prompt specific to the one or more fraud categories.

14. The method of claim 13, further comprising:
deriving the plurality of features either directly from the piece of content or indirectly from an external source associated with the piece of content.

15. The method of claim 13, further comprising:
transforming the plurality of derived features into a set of numerical values representing the one or more fraud categories to facilitate classification by the one or more classification models.

16. The method of claim 13, further comprising:
blocking the piece of content if the piece of content is classified as fraudulent.

17. The method of claim 13, wherein:
the input prompt is pre-defined by a user for each of the one or more fraud categories.

18. The method of claim 17, further comprising:
accepting a plurality of pre-defined category-specific prompts from the user; and
maintaining one or more pairs of the plurality of pre-defined category-specific prompts together with their corresponding fraud categories in a lookup table.

19. The method of claim 18, further comprising:
looking up the one or more fraud categories and retrieve the corresponding input prompt from the lookup table.

20. The method of claim 13, further comprising:
generating the fraud report at the input prompt either automatically without manual intervention by a human operator or upon a request from the user.

21. The method of claim 13, further comprising:
personalizing the generated fraud report to provide one or more insights for the user.

22. The method of claim 13, further comprising:
fine-tuning the LLM by utilizing previously available data, wherein the previously available data includes previously generated fraud reports for the same or similar input prompt.

23. A non-transitory storage medium having software instructions stored thereon that when executed cause a system to:
derive a plurality of features from a piece of content for fraud detection;
classify the plurality of features of the piece of content into one or more fraud categories using one or more classification models;
accept the plurality of derived features and their corresponding one or more fraud categories and/or the plurality of derived features;
generate an input prompt to a large language model (LLM), wherein the input prompt is specific to the one or more fraud categories; and
utilize the LLM to generate a fraud report of the original piece of content for a user based on the input prompt specific to the one or more fraud categories.
